(19) United States
(12) Patent Application Publication
(10) Pub. No.: US 2016/0220070 A1
(43) Pub. Date: Aug. 4, 2016

(54) FOOD PROCESSOR

(71) Applicant: Vorwerk & Co. Interholding GmbH, Wuppertal (DE)

(72) Inventors: Jutta SCHOMACHER, Wuelfrath (DE); Torsten LANG, Solingen (DE)

(73) Assignee: Vorwerk & Co. Interholding GmbH, Wuppertal (DE)

(21) Appl. No.: 15/014,151

(22) Filed: Feb. 3, 2016

(30) Foreign Application Priority Data
Feb. 4, 2015 (EP) 15153808.9

(51) Int. Cl. A47J 43/07; G05B 15/02; B02C 25/00; G06F 17/30

(52) U.S. Cl. CPC A47J 43/07; G06F 17/30312; G05B 15/02; B02C 25/00

(57) ABSTRACT

The invention relates to a method for preparing a meal with a food processor (1) based on a recipe, wherein a mobile data storage (4) is connected with a communication interface (3) of the food processor (1), so as to transfer data of a recipe contained in the mobile data storage (4) to the food processor (1) to control preparation steps. In order to allow the user to select and display recipes more comfortably, in particular more quickly, it is proposed that a data processor (5) of the food processor (1) combine a first data portion {6} of the recipe contained in a machine data storage {2} of the food processor (1) and a second data portion (7) of the recipe contained in the mobile data storage (4) to yield a complete data record (8), and based on the complete data record (8) generate commands for controlling preparation steps of the food processor (1). In addition, the invention relates to a corresponding food processor, as well as to a food processor system.

The invention relates to a method for preparing a meal with a food processor based on a recipe, wherein a mobile, data storage is connected with a communication interface of the food processor, so as to transmit data of a recipe contained in the mobile data storage to the food processor to control preparation steps. The invention also relates to a food processor for implementing the method.

Food processors for preparing meals are known in the art as universal electric food processors. In addition to mechanically processing foods, for example with a mixer or cutting blade, the latter often also make it possible to cook foods with a heater. Cooking recipes are usually provided for preparing a meal, and exhibit several consecutive preparation steps. To allow the user of a food processor to prepare a meal according to a cooking recipe, it is also known to file recipe data in a machine data storage of the food processor, or alternatively in a mobile data storage that can be connected with the food processor.

For example, known from publication EP 2 801 928 A1 is a food processor that executes preparation steps in chronological order based on a recipe stored in a mobile data storage, wherein the preparation steps are distinguished by varying process parameters, such as processing temperature, mixer speed or duration of a preparation step.

What can be uncomfortable here is that the user, depending on a higher or lower quantity of stored data, must take a certain amount of time when choosing the recipe to select the displayed data records and pick out a desired recipe. In particular given very large quantities of stored data, the search for and display of recipes can be a slow, and thus uncomfortable process.

Therefore, the object of the invention is to develop a method or food processor that allows the user to select and display recipes more comfortably, in particular more quickly.

In order to achieve this object, the invention initially proposes a method in which a data processor of the food processor combines a first data portion of the recipe contained in a machine data storage of the food processor and a second data portion of the recipe contained in the mobile data storage to yield a complete data record, and based on the complete data record generates commands for controlling preparation steps of the food processor.

According to the invention, the storage space required in the machine data storage of the food processor can now be reduced by having the machine data storage of the food processor and mobile, external data storage, which can be connected to the food processor via a communication interface, interact with each other in such a way that the latter exhibit corresponding data portions, specifically the first and second data portions, which can be combined to yield a complete data record. In this regard, for example, it is possible have the machine data storage store only those data portions, specifically first data portions, required by a user of the food processor, e.g., in order to gain an overview of available recipes and their ingredients. As a consequence, the invention is simultaneously based on the knowledge that the user does not require all data portions of a recipe for specific working steps on the food processor, e.g., selecting at recipe, but rather only very specific information, which comprises a first data portion of the data, making up the complete data record. Because the data volume inside of the machine data storage is thus reduced overall, the speed with which the user can access stored data is increased. In particular, it is possible to search through the data portions stored in the machine data storage more quickly and/or display them on screen or have them rendered in some other way. It is here advantageous that the machine data storage contain only the information required by the user of the food processor at an early point in preparation, in particular before preparation devices of the food processor start, operating, such as the mixer or a heater.

The additional data portions-second data portions-required for completely preparing a meal are stored in the mobile, external data storage, for example, and are available to the user as soon as he or she connects the latter with a communication interface of the food processor. This distinctly increases the overall storage economy. In like manner, for example, changes affecting only the data content of the data portions stored in the mobile data storage can foe actualized especially easily and comfortably, without a data connection with the food processor having to be established. In order to change stored data portions or supplement new data portions, the mobile data storage can instead be connected with an external computer, for example a personal computer or a server (e.g., a “cloud”), so as to perform a conventional data storage on a mobile data storage, for example a USB stick or memory card. The user can thus refer back to working steps already familiar to him or her.

It is proposed that the second data portion be transferred to the machine data storage and/or to the data processor prior to being combined with the first data portion, and/or that the first data portion be transferred to the mobile data storage and/or to the data processor prior to being combined with the second data portion.

In a first variant, a data portion is transferred from the mobile data storage to the machine data storage, so as to there combine the first, data portion and second data portion to yield a complete data record (recipe). Alternatively, a data portion contained in the machine could also be transferred to the mobile data storage. Likewise, it is also possible to execute a data transfer in both directions, i.e., a data portion is transferred from the machine data storage to the mobile data storage, and a data portion is also transferred from, the mobile data storage to the machine data storage. As a consequence, the complete data record is kept available simultaneously in either the machine data storage, the mobile data storage or in both data storages.

In a second variant, a data portion is transferred from, the mobile data storage and/or the machine data storage to the data processor. As a consequence, the data portion is first transferred to the data processor before the latter subsequently transfers the data to a storage location, for example to a storage location different than the mobile data storage and the machine data storage. With reference to the aforementioned second variant, it is proposed that the data processor link the first data portion and the second data portion to yield a data record, and briefly store it in a temporary storage for the time the meal is being prepared. In this variant, the data portions are merely linked in such a way that the first data portion or the second, data portion is not stored in the mobile data storage or machine data storage, but rather at a third storage location independent thereof. The content of the machine data storage or mobile data storage remains unchanged.

It is proposed that the first data portion exhibit a recipe title and/or recipe ingredients. The machine data storage of the food processor thus contains only those first data portions that the user requires in an early step with the food processor. The recipe title can provide the user with a table of contents of the recipes available in combination with the mobile data storage. If the first data portion contains recipe ingredients, the user can decide whether or not he or she would like to prepare the recipe in question based on the ingredients. At this point in time, the user usually does not require any further information about process parameters, such as heating temperature, speed and the like, so that the latter need not be made available in the machine data storage of the food processor.

It is further provided that the second data portion exhibit programmatic instructions for preparing the meal. The second data portion, which is stored in the mobile data storage, thus contains the information necessary for preparing the meal, such as the process parameters of temperature, speed, heating duration, mixing duration, and so on. As a consequence, the programmatic instructions indicate the specific details of the recipe for being able to perform the consecutive preparation steps.

Also proposed apart front the aforementioned method is a food processor for preparing a meal based on a recipe, wherein the food processor exhibits a machine data storage, a communication interface for connection with at least one mobile data storage, and a data processor, wherein the data processor is designed to convert data contained in a recipe into commands for controlling preparation steps of the food processor, wherein the data processor is designed to combine a first data portion of the recipe stored in the machine data storage with a second data portion of the recipe stored in the mobile data storage to yield a complete data record of the recipe.

It is proposed that the communication interface be designed for the data transfer of data portions between the mobile data storage and the stationary data storage and/or the mobile data storage and the data processor.

It is also proposed that the food processor exhibit an optical output device, which displays the commands for controlling the preparation steps. The optical output device can be a display, which shows the commands for controlling the preparation steps that the data processor retrieved from the complete data record of the recipe. The user of the food processor can thereupon manually initiate the preparation steps. For example, the command “cook for 10 minutes at 100° C” can be displayed, after which the user sets a corresponding duration and heating temperature on the food processor. The optical output device can be the same output device that also shows the user the first data portions stored in the machine, data storage of the food processor, for example a table of contents with recipe titles.

In addition, the food processor can exhibit a controller, which is designed to automatically or semi-automatically control a preparation device, in particular a heater and/or mixer, of the food processor as a function of the commands for controlling preparation steps. Alternatively or additionally to optically displaying the commands for controlling preparation steps, the preparation steps for the food processor can be automatically or semi-automatically controlled in this embodiment. The data processor combines the first data portion and second data portion to yield a complete data record of the recipe, converts the data contained in the recipe into commands for controlling preparation steps of the food processor, and then automatically or semi-automatically controls the preparation devices of the food processor, for example a heater and/or a mixer or the like. In the semi-automatic control mode, the user is shown additional commands by the optical output device, and must provide a confirmation to actually initiate the preparation step. For example, the command “Start mixer, speed 1,000 RPM” is displayed to the user on the optical output device, wherein the user must press a confirmation key or some other input command to actually start the preparation step.

It is proposed that the data processor have allocated to it a temporary storage, wherein the data processor is designed to link the first data portion and second data portion to yield a data record, and briefly store the linked data record in the temporary storage for the time the meal is being prepared. No back-and-forth exchange of data between the machine data storage and mobile data storage here takes place. Instead, the first data portion of the machine data storage and second data portion of the mobile data storage are stored inside of a third data storage, specifically a temporary storage. For example, the temporary storage can be a virtual storage, or also a temporary file. Inside of the temporary storage, the two data portions are linked to yield a data record and stored for the time the meal is being prepared, so that the latter is available to the data processor and/or a controller for preparing the meals. After the meal has been prepared, the data portions are again deleted from the temporary storage and/or overwritten with new data records. The data portions contained in the machine data storage or mobile data storage remain unchanged in this respect, the storage economy according to the invention is retained, wherein the machine data storage only contains those data portions required by the user for selecting a recipe. The detailed data portions that contain specific programmatic instructions for preparing the meal are instead filed in the mobile data storage.

Alternatively, it can be provided that the data processor be designed to copy the first data portion to the mobile data storage and/or copy the second data portion to the machine data storage, and there combine them to yield a complete data record of the recipe. In this alternative, a possibly reciprocal exchange of data takes place between the machine data, storage and mobile data storage. Once the user has selected a specific recipe for preparation, the second data portion contained in the mobile data storage. for example which contains the programmatic instructions for preparing the meal and controlling the preparation device, is copied to the machine data storage, and here combined to yield a complete data record. After preparation is complete, the second data portion can either be deleted from the machine data storage again or remain there, so as to already be completely available if the user wishes to cook the recipe a second time later. Likewise, it is of course also possible to copy the first data portion of the machine data storage to the mobile data storage, and combine it with the second data portion to yield a complete data record of the recipe. When copying the first data portion to the mobile data storage or the second data portion to the machine data storage, the machine data storage and mobile data storage can be designed to communicate directly with each other. Alternatively, the copied data portion can also first be transferred to the data processor, which then transfers the data portion to the other data storage. As soon as the first data portion and second data portion within the machine data storage and/or mobile data storage have been combined to yield a complete data record, of the recipe, this complete data record can again be transferred to the data processor, so that the latter can convert the data contained in the recipe into commands for controlling preparation steps of the food processor.

The data connection established between the machine data storage and mobile data storage or mobile data storage and data processor by means of the communication interface of the food processor can be encrypted to prevent third parties from accessing the data. In addition, a compatibility check may be provided, which verifies whether the mobile data storage is compatible with the machine data storage before connecting the mobile data storage with the machine data storage or data processor. Should the compatibility check reveal that the machine data storage and mobile data storage are not compatible with each other, a warning can be displayed to the user of the food processor on the optical output display of the food processor. Warning sounds or the like are also conceivable as an alternative.

Also proposed in addition to the food processor according to the invention described above is a food processor system that exhibits a food processor with machine data storage for preparing a meal according to a recipe and at least one mobile data storage that can be connected with the food processor for exchanging data, in particular a USB stick or memory card, wherein the food processor exhibits a data processor designed to convert the data contained in the recipe into commands for controlling preparation steps of the food processor. It is proposed that the machine data storage exhibit a first data portion of data contained in the recipe, and that the mobile data portion exhibit a second data portion of data contained in the recipe, wherein the data processor is designed to combine the first data portion and second data portion to yield a complete data record of the recipe. The components of the food processor system, i.e., the machine data storage and mobile data storage, here work together according to the invention in the way explained previously in relation to the food processor. The food processor is designed according to one or more of the features described above, so that an optimal overall storage economy is ensured between the two data storages, and the user can perform a search and/or display of available recipes especially quickly.

Finally, it can be provided that the mobile data storage exhibit a larger storage capacity than the machine data storage of the food processor. Since the comprehensive programmatic instructions for preparing a meal are stored in the mobile data storage according to the invention, a correspondingly larger storage capacity is required than for the machine data storage, for example which must only contain recipe titles and/or recipe ingredients of the recipes to provide the user with a selection of available recipes in the form of a table of contents. The small storage capacity of the machine data storage enables an especially quick search within the stored first data portions, so that the user is comfortably supported during the selection of a recipe.

The invention will be described in greater detail below based on exemplary embodiments. Shown on:

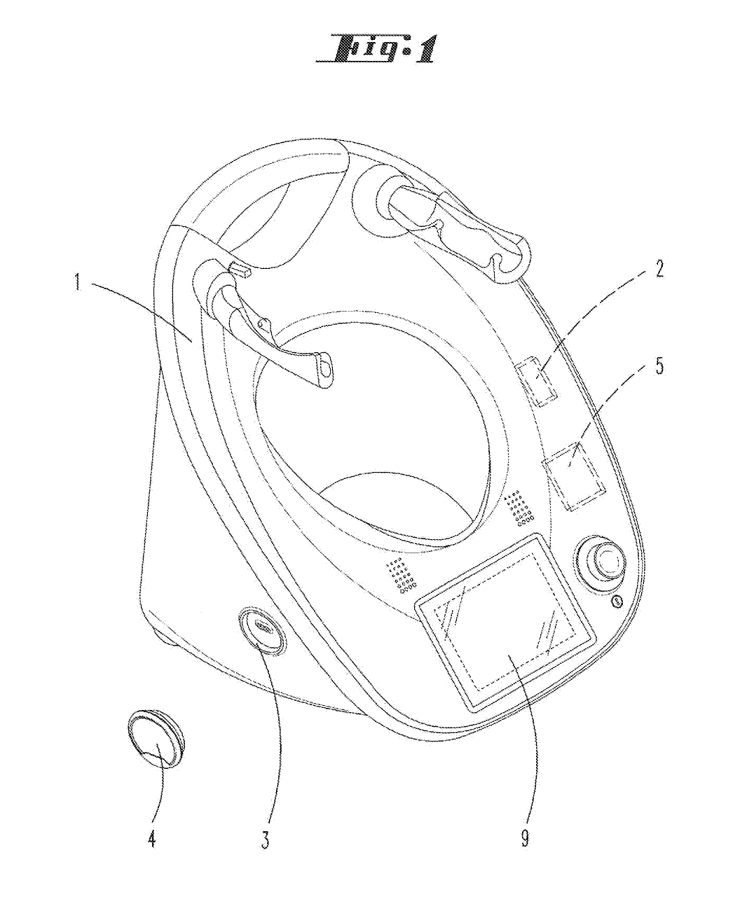

FIG. 1 is a perspective view of a food processor according to the invention;

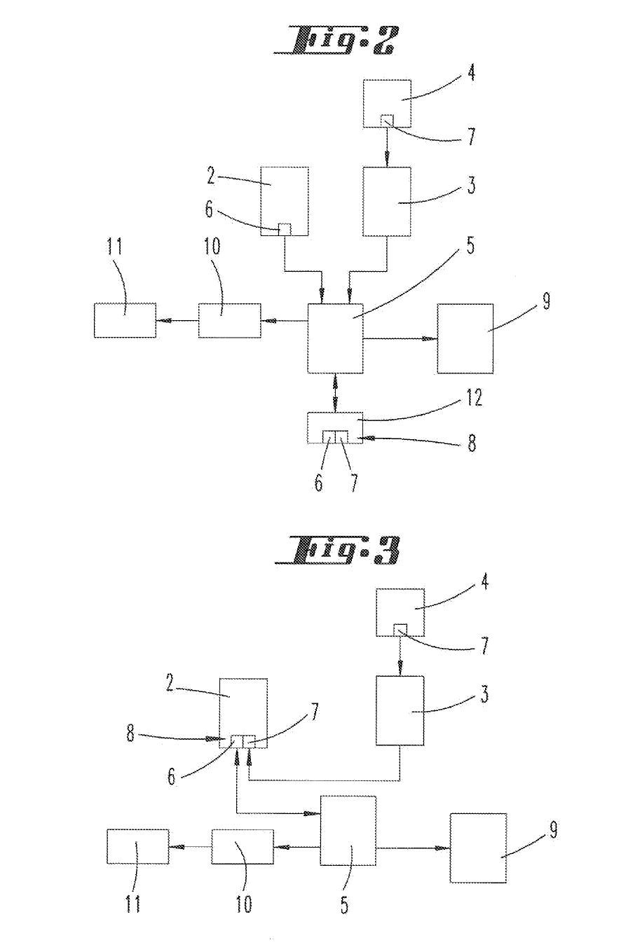

FIG. 2 is a diagram of how a machine data storage and a mobile data storage interact by linking data portions in a temporary storage;

FIG. 3 is a diagram of how a machine data storage and a mobile data storage interact by copying a data portion of the mobile data storage to the machine data storage.

The depicted food processor 1 is a conventional cooking and mixing device, which can be used for preparing a meal based on a recipe. The food processor 1 exhibits several preparation devices 11, for example a mixer and a heater. The food processor 1 further exhibits a mixing bowl 13, into which ingredients can be introduced for preparing a meal. Arranged inside the food processor 1 is a machine data storage 2, along with a data processor 5 and controller 10 for controlling the preparation devices 11. Furthermore, the food processor 1 exhibits an output device 9, here a display, which serves to display information to the user. The food processor 1 further exhibits a communication interface 3, which can be connected with at least one mobile data storage 4. The mobile data storage 4 is here a USB stick, for example.

The machine data storage 2 of the food processor 1 exhibits several first data portions 6, wherein each first data portion 6 is allocated, to a specific recipe. The mobile data storage 4 or mobile data storages 4 (in the event several mobile data storages 4 can be connected with the food processor 1) exhibit(s) several second data portions 7, which can be combined with the first, data portions 6 to yield complete data records 8 of the recipes. For example, the first data, portions 6 involve recipe titles and/or recipe ingredients, which allow the user to select a recipe before starting to prepare the meal, i.e., before a preparation device 11 is actuated. The recipe titles of several first data portions can here be organized as a kind of table of contents, which affords the user with a simple and quick selection. If necessary, the recipe titles can be supplemented to indicate the respectively required recipe ingredients, thereby providing the user with an overview of whether he or she has the ingredients necessary for preparation. Corresponding to the first data portions 6, the second data portions 7 contain programmatic instructions for preparing the meal for the respective recipe. These programmatic instructions serve to control the preparation devices 11 of the food processor 1 via the controller 10.

Two alternative embodiments will be described in greater detail, below. FIG. 2 here shows a first variant, in which the first data portion 6 and second data portion 7 of a recipe are linked with each other in such a way that the combined, complete data record 8 is only filed in a temporary storage 12. By contrast, the variant according to FIG. 3 shows that the first data portion 6 and second data portion 7 are joined by copying the second data portion 7 from the mobile data storage 4 to the machine data storage 2 of the food processor 1, so that the complete data record 8 is available in the machine data storage 2.

As shown in detail on FIG. 2, the machine data storage 2 of the food processor 1 contains a first data portion 6, here a recipe title and an indication of ingredients required for the recipe. The mobile data storage 4, specifically the USB stick, contains a second data portion 7 with programmatic instructions for preparing the meal according to the recipe. The mobile data storage 4 is hooked up to the communication interface 3 of the food processor 1, and further has a data connection with the data processor 5, which likewise has a data connection with the machine data storage 2. The data processor 5 reads the first data portion 6 and second data portion 7 from the machine data storage 2 or mobile data storage 4, and transfers the latter to a temporary storage 12, here for example a virtual storage, which contains the first data portion 6 and second data portion 7 combined to yield a complete data record 8. The data processor 5 accesses this complete data record 8 to convert the data contained therein into commands for controlling preparation steps of the food processor. The data processor 5 transfers these command for controlling preparation steps to the controller 10, which thereupon, starts a preparation device 11, here for example a heater, and operates it as a function of the content of the command, for example over a specific period of time. The controller 10 semi-automatically controls the preparation device 11 as a function of the commands of the data processor 5. The user of the food processor 1 is here simultaneously shown current commands by the output device 9, here a display, whereupon the user must confirm, the displayed command to initiate execution of the command, i.e., control of the preparation device 11.

FIG. 3 presents a detailed view of a second embodiment variant in which the machine data storage 2 also exhibits a first data portion 6 as explained above, and the mobile data storage 4 also exhibits a second data portion 7, Contrary to the embodiment variant according to FIG. 2, the second data portion 7 is here copied by the communication interface 3 into the machine data storage 2 of the food processor 1, so that the machine data processor 2 contains both the first data portion 6 and the second data portion 7, so that a complete data record 8 is available within the machine data storage 2. The data processor 5 accesses this complete data record 8 within the machine data storage 2, and in turn converts the latter into commands for controlling preparation devices 11 of the food processor 1, wherein the data processor 5 optically outputs the commands for controlling preparation steps to the user via the output device 9 on the one hand, and on the other hand relays them to the controller 10, so as to correspondingly control the preparation device 11. The information displayed via the output device 9 can serve exclusively as information for the user, without the latter having to confirm a control command. Accordingly, it can be provided that the data processor 5 automatically relays a command to the controller 10, which thereupon automatically initiates control of the preparation device 11. In this fully automated control of the preparation device 11, the user of the food processor 1 must ensure that he or she fills the mixing bowl 13 of the food processor 1 with the corresponding ingredients in a timely manner. He or she can here derive the current preparation status of the food processor 1, i.e., the next preparation step, from the information displayed, via the output device 9.

### REFERENCE LIST

1. Food processor
2. Machine data storage
3. Communication interface
4. Mobile data storage
5. Data processor
6. First data portion
7. Second data portion
8. Data record
9. Output device
10. Controller
11. Preparation device
12. Temporary storage
13. Mixing bowl

1. A method for preparing a meal with a food processor (1) based on a recipe, wherein a mobile data storage (4) is connected with a communication interface (3) of the food processor (1), so as to transmit data of a recipe contained in the mobile data storage (4) to the food processor (1) to control preparation steps, wherein a data processor (5) of the food processor (1) combines a first data portion (6) of the recipe contained in a machine data storage (2) of the food processor (1) and a second data portion (7) of the recipe contained in the mobile data storage (4) to yield a complete data record (8), and based on the complete data record (8) generates commands for controlling preparation steps of the food processor (1).

2. The method according to claim 1, wherein the second data portion (7) is transferred to the machine data storage (2) and/or to the data processor (5) before combined with the first data portion (6), and/or that the first data portion (6) is transferred to the mobile data storage (4) and/or to the data processor (5) before combined with the second data portion (7).

3. The method according to claim 1, wherein the data processor (5) links the first data portion (6) and second data portion (7) to yield a data record (8), and briefly stores it in a temporary storage (12) for the time the meal is being prepared.

4. The method according to claim 1, wherein the data processor (5) copies the first data portion (6) to the mobile data storage (4) and/or copies the second data portion (7) to the machine data storage (2), and there combines them to yield a complete data record (8).

5. A food processor (1) for preparing a meal based on a recipe, wherein the food processor (1) exhibits a machine data storage (2), a communication interface (3) for connection with at least one mobile data storage (4), and a data processor (5), wherein the data processor (5) is designed to convert data contained in a recipe into commands for controlling preparation steps of the food processor (1), wherein the data processor (5) is designed to combine a first data portion (6) of the recipe stored in the machine -data storage (2) with a second data portion (7) of the recipe stored in the mobile data storage (4) to yield a complete data record (8) of the recipe.

6. The food processor (1) according to claim 5, wherein the communication interface (3) is designed for the data transfer of data portions (6, 7) between the mobile data storage (4) and machine data storage (2) and/or the mobile data storage (4) and data processor (5).

7. The food processor (1) according to claim 5, comprising an optical output device (9) that displays the commands for controlling preparation steps.

8. The food processor (1) according to claim 5, comprising a controller (10) designed to automatically or semi-automatically control a preparation device (11), in particular a heater and/or a mixer, of the food processor (1) as a function of the commands for controlling the preparation steps.

9. A food processor system with a food processor (1) exhibiting a machine data storage (2), in particular a food processor (1) according to claim 1, for preparing a meal based on a recipe and with at least one mobile data storage (4), in particular a USB stick or memory card, that can be connected with the food processor (1) for data communication, wherein the food processor (1) exhibits a data processor (5) designed to convert data contained in the recipe into commands for controlling preparation steps of the food processor (1), wherein the machine data storage (2) exhibits a first data portion (6) of data contained in the recipe, and that the mobile data storage (4) exhibits a second data portion (7) of data contained in the recipe, wherein the data processor (5) is designed to combine the first data portion (6) and second data portion (7) to yield a complete data record (8) of the recipe.

10. The food processor system according to claim 9, wherein the mobile data storage (4) exhibits a larger storage capacity than the machine data storage (2) of the food processor (1).
